(19) United States
(12) Patent Application Publication
(10) Pub. No.: US 2024/0176989 A1
(43) Pub. Date: May 30, 2024

(54) TRAJECTORY PREDICTING METHODS AND SYSTEMS

(71) Applicant: NANYANG TECHNOLOGICAL UNIVERSITY, Singapore (SG)

(72) Inventors: Chen LYU, Singapore (SG); Xiaoyu MO, Singapore (SG)

(73) Assignee: NANYANG TECHNOLOGICAL UNIVERSITY, Singapore (SG)

(21) Appl. No.: 18/285,077

(22) PCT Filed: Apr. 26, 2022
(86) PCT No.: PCT/SG2022/050247

§ 371 Date: Sep. 29, 2023

(30) Foreign Application Priority Data
Apr. 26, 2021 (SG) 10202104210U

(51) Int. Cl. G06N 3/0455; B60W 60/00

(52) U.S. Cl. CPC G06N 3/0455; B60W 60/0027; B60W 2556/10

(57) ABSTRACT

A method of determining a predicted trajectory of a moving object. The method comprises obtaining historical trajectory data for the moving object and for one or more neighbouring objects; passing the historical trajectory data to a RNN encoder to generate dynamic features for the moving object and the one or more neighbouring objects; constructing a graph representing interactions between the moving object and the one or more neighbouring objects, wherein each node of the graph repre-sents one of the moving object or one of neighbouring objects, and comprises the respective dynamic features of the moving object or the one or more neighbouring objects, and each edge represents an effect of the moving object on a neighbouring object or vice versa, or an effect of a neighbouring object on another neighbouring object; passing the graph and the dynamic features to a GNN encoder to generate a plurality of interaction features; and passing the dynamic features and the interaction features to a RNN decoder to generate the predicted trajectory.

### TECHNICAL FIELD

The present invention relates, in general terms, to methods and systems of determining predicted trajectory, and also relates to methods and systems of determining predicted trajectory of moving objects.

### BACKGROUND

Autonomous driving is expected to improve the safety and efficiency of our daily transportation thanks to the technological advancements in both algorithms and hardware. Researchers argue that autonomous vehicles will be safer if they can precisely predict the future locations of surrounding vehicles. Many trajectory prediction methods have been proposed. However, trajectory prediction is challenging in that driving is a complex interactive behaviour, where the motion of a vehicle is affected not only by its own driving style but also the styles of surrounding vehicles. Moreover, the number of surrounding vehicles can vary in different traffic situations.

Previous works on trajectory prediction are grouped into three categories, namely physics based, manoeuvre-based, and interaction-aware methods. Physics-based methods consider only the target agent's kinematic measurements and assume that the agent will move at a constant velocity or acceleration. Manoeuvre-based methods consider intents of the target agent and predict its motion conditioned on these intents. The intents are often affected by the road structure and possible manoeuvres (e.g., acceleration and lane change). Interaction-aware methods, sometimes augmented with physics-based and/or manoeuvre-based methods, consider the interaction among many objects for prediction.

Most recent works have proposed to jointly consider the target agent's own dynamics, its interaction with surrounding agents, and the impacts of infrastructure. They represent the agents and the map either separately or integrally and try to predict multi-modal future motions of target agents. Most existing works predict a predefined number of possible future motions of a target agent. A prediction set with a fixed number of options limits the generalizability of the model for complex map geometries.

It would be desirable to overcome all or at least one of the above-described problems.

### SUMMARY

Disclosed herein is a system for determining a predicted trajectory of a moving object. The system comprises memory; and at least one processor in communication with the memory. The memory stores machine-readable instructions for causing the at least one processor to:
receive historical trajectory data for the moving object and for one or more neighbouring objects;
pass the historical trajectory data to a recurrent neural network (RNN) encoder to generate dynamic features for the moving object and the one or more neighbouring objects;
construct a graph representing interactions between the moving object and the one or more neighbouring objects, wherein each node of the graph represents either the moving object or one of neighbouring objects, and comprises the respective dynamic features of moving object or said one of the neighbouring objects, and each edge represents an effect of the moving object on a neighbouring object or vice versa, or an effect of a neighbouring object on another neighbouring object;
pass the graph and the dynamic features to a graph neural network (GNN) encoder to generate a plurality of interaction features; and
pass the dynamic features and the interaction features to a RNN decoder to generate the predicted trajectory.

In some embodiments, the graph is a directed graph.

In some embodiments, the graph is a star-like graph.

In some embodiments, the RNN encoder is a gated recurrent unit (GRU).

In some embodiments, the GRU is a 1-layer GRU.

In some embodiments, the RNN decoder is a LSTM.

In some embodiments, the LSTM is a 2-layer LSTM.

In some embodiments, the GNN comprises two graph attention network (GAT) layers.

In some embodiments, the GAT layers utilise a three-head attention mechanism.

In some embodiments, the moving object and/or the one or more neighbouring objects is or are a vehicle or vehicles.

Disclosed herein is also a method of determining a predicted trajectory of a moving object. The method comprises:
obtaining historical trajectory data for the moving object and for one or more neighbouring objects;
passing the historical trajectory data to a RNN encoder to generate dynamic features for the moving object and the one or more neighbouring objects;
constructing a graph representing interactions between the moving object and the one or more neighbouring objects, wherein each node of the graph represents one of the moving object or one of neighbouring objects, and comprises the respective dynamic features of the moving object or the one or more neighbouring objects, and each edge represents an effect of the moving object on a neighbouring object or vice versa, or an effect of a neighbouring object on another neighbouring object;
passing the graph and the dynamic features to a GNN encoder to generate a plurality of interaction features; and
passing the dynamic features and the interaction features to a RNN decoder to generate the predicted trajectory.

Disclosed herein is also non-transitory machine-readable storage comprising machine-readable instructions for causing at least one processor to carry out the proposed method.

### BRIEF DESCRIPTION OF THE DRAWINGS

Embodiments of the present invention will now be described, by way of non-limiting example, with reference to the drawings in which:

FIG. 1 illustrates an example high-level architecture of the proposed method for determining a predicted trajectory of a moving object;

FIG. 2 illustrates box plots of the RMSE of implemented models;

FIG. 3 illustrates visualized STP predictions;

FIG. 4 illustrates visualized MTP predictions;

FIG. 5 illustrates an example high-level architecture of the proposed method for performing multi-model trajectory prediction;

FIG. 6 illustrates agent and CCL encoders;

FIG. 7 illustrates information flow in an example hierarchical graph operator;

FIG. 8 illustrates an example candidate centre-lines guided predictor; and

FIG. 9 is a schematic diagram showing components of an exemplary computer system for performing the methods described herein.

### DETAILED DESCRIPTION

The present invention relates to graph-neural-network-based (GNN-based) deep learning for trajectory prediction for multiple agents. Integrating trajectory prediction into the decision-making and planning modules of modular autonomous driving systems is expected to improve the safety and efficiency of self-driving vehicles. However, a vehicle's future trajectory prediction is a challenging task since it is affected by the social interactive behaviours of neighbouring vehicles, and the number of neighbouring vehicles can vary in different situations. The present invention proposes a GNN-recurrent neural network (GNN-RNN) based Encoder-Decoder network for interaction-aware trajectory prediction, where vehicles' dynamics features are extracted from their historical tracks using RNN, and the inter-vehicular interaction is represented by a graph (generally a directed graph) and encoded using a GNN. The parallelism of GNN implies the potential of the proposed method to predict multi-vehicular trajectories simultaneously. Evaluation on the dataset extracted from the NGSIM US-101 dataset shows that the proposed model is able to predict a target vehicle's trajectory in situations with a variable number of surrounding vehicles.

Embodiments of the present invention improve the CNN-LSTM-based trajectory prediction method proposed by integrating RNNs and GNNs to handle the situation with a varying number of surrounding vehicles and investigates the potential of graph modelling on multi-vehicular trajectory prediction. The proposed model can use RNNs to extract dynamics features of all vehicles, then applies a GNN on a star-like directed graph, where a node corresponding to a vehicle contains its sequential feature and an edge from one node to another node implies that the latter's behaviour is affected by the former, to summarize the inter-vehicular interaction. An RNN decoder is applied to the combination of the target vehicle's dynamics feature and its interaction feature for single vehicular trajectory prediction.

Also described is the expansion of the proposed GNN-based deep learning method to multi-modal trajectory prediction. Predicting the multi-modal future motions of surrounding agents is essential for an autonomous vehicle to navigate in complex scenarios. It is challenging as the motion of an agent is affected by the complex interaction among itself, other agents, and the road structure. Unlike most existing works, which predict a fixed number of possible future motions of an agent, present methods propose a map-adaptive predictor that can predict a variable number of future trajectories of an agent according to the number of its candidate centre-lines (CCLs). The predictor predicts not only future motions guided by a single CCL, but also a cross centre-line prediction and a motion-based prediction. These three kinds of predictions are produced integrally via a single graph operator. The driving scene is represented with a heterogeneous hierarchical graph, wherein a node represents either an agent or its CCL. An agent node contains its dynamics feature encoded from its historical states and a CCL node contains the CCL's sequential feature. A hierarchical graph operator with an edge masking technology is proposed to regulate the information flow in graph operators and obtain the encoded scene feature for the prediction header. Experiments on the real-world driving dataset show that present methods match the performance of state-of-the-art methods on the Argoverse motion forecasting benchmark and the proposed predictor is able to simultaneously predict map-compliant and motion-based trajectories within a single graph operation.

Present methods attempt to represent the complex driving scene and predict multi-modal motions of a target vehicle in an integrated manner. The driving scene is represented with a heterogeneous hierarchical graph, wherein a node is either an agent or its candidate centre-line (CCL) and contains the corresponding feature. The present disclosure proposes a three-stage graph operator to encode the scene graph, where an edge-masking technology is used to regulate information flow in different stages. The present disclosure designs an integrated multi-modal predictor via graph operation and edge-masking that can simultaneously predict single CCL guided, cross-CCL, and motion-based future trajectories of a target agent. The graph operation allows the proposed predictor to predict a variable number of trajectories according to the target agent's CCLs.

The main contributions of the present methods are summarized as follows. First, the present disclosure proposes a graph-based interaction-aware trajectory prediction method. A map-adaptive multi-modal trajectory prediction frame is designed, which jointly considers the target agent's own dynamics, its interaction with other agents, and the road structure. Second, a comprehensive CCL-guided multimodal predictor is proposed, that is implemented with graph operation and edge-masking technology. The CCL-guided multimodal predictor produces three kinds of predictions, that is 1) a set of centre-line guided trajectories that is adaptive to the road topology and can generalize to unseen road structures; 2) a cross centre-line trajectory considering the overall topology since a driver will not always follow a single centre-line; and 3) a non-interactive trajectory to cover the corner-case where the vehicle is not following the topology. Third, ablative studies are conducted to show the necessity to jointly consider individual dynamics and interaction features. In particular, experiments are conducted on the Argoverse motion forecasting dataset, and shows that the proposed method matches state-of-the-art performance. Fourth, the potential of the proposed method to be applied to multi-vehicular trajectory prediction is investigated.

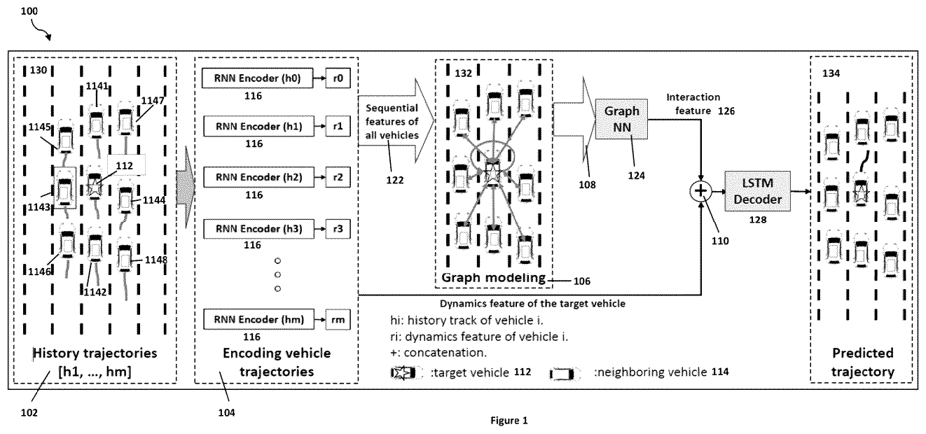

The present disclosure now formulates the trajectory prediction problem and proposes a two-channel Encoder-Decoder structure, which consists of history encoder, interaction encoder, and future decoder, for this problem. FIG. 1 illustrates an example method 100 of determining a predicted trajectory of a moving object. Incidentally, it will be understood that a non-transitory machine-readable storage may be used to store machine-readable instructions for causing at least one processor to carry out the method 100. As shown in FIG. 1, RNNs with shared weights are used to encode the dynamics features of vehicles individually. A GNN-based interaction encoder is applied to these dynamics features, which are contained in corresponding nodes in a directed interaction graph, to summarize the inter-vehicular interaction feature. Finally an LSTM decoder predicts the trajectory by jointly considering the target vehicle's dynamics and interaction features. The method 100 comprises:
Step 102: obtaining historical trajectory data 130 for the moving object 112 and for one or more neighbouring objects 114;
Step 104: passing the historical trajectory data to a RNN encoder 116 to generate dynamic features 122 for the moving object 112 and the one or more neighbouring objects 114;
Step 106: constructing a graph 132 representing interactions between the moving object 112 and the one or more neighbouring objects 114, wherein each node of the graph represents one of the moving object or one of neighbouring objects, and comprises the respective dynamic features of the moving object or the one or more neighbouring objects, and each edge represents an effect of the moving object on a neighbouring object or vice versa, or an effect of a neighbouring object on another neighbouring object;
Step 108: passing the graph 132 and the dynamic features 122 to a GNN encoder 124 to generate a plurality of interaction features 126; and
Step 110: passing the dynamic features 122 and the interaction features 126 to a RNN decoder 128 to generate the predicted trajectory 134.

The method 100 aims to predict the future trajectory 134 of a target vehicle 112 driving on a highway given historical trajectories 130 of its up-to-eight surrounding vehicles 114. As shown in FIG. 1, the method 100 considers two kinds of vehicles: the target vehicle 112 and its neighbouring vehicles 114. Neighbouring vehicles 114 considered are the target vehicle's preceding (1141) and following (1142) vehicles, its nearest neighbours in adjacent lanes (1143 and 1144), in terms of longitudinal distance, and their preceding (1145 and 1147) and following (1146 and 1148) vehicles.
Step 102 involves obtaining historical trajectory data for the moving object 112 and for one or more neighbouring objects 114. The input to the model ( [symbol] ) is a set of historical trajectories of all considered vehicles, including the target vehicle 112.

[symbol]

={hₜ⁰,hₜ¹, . . . ,hₜ^{m}}

where hₜⁱ=[p_{t-T}_{ₕ}₊₁ⁱ, pₜ₋_{ₕ}₊₂ⁱ, . . . , pₜⁱ] represents the sequence of historical trajectory of vehicle i at time t. Tₕ is the traceback horizon. Without loss of generality, The target vehicle 112 is numbered 0 and the neighbouring vehicles 1141 to 1148 are numbered from 1 to m∈[1,8].

The output is the predicted future trajectory of the target vehicle at time t:

fₜ⁰=[pₜ₊₁ⁱ,pₜ₊₂ⁱ, . . . ,p_{t+T}_{_{f}}ⁱ]

where T_{f} is the prediction horizon. As will be discussed in detail, the predicted future trajectory of the target vehicle will be generated at step 110.

To solve the single trajectory prediction problem, a GNN-RNN based model is designed under the Encoder-Decoder structure and consists of two encoders (history encoder, interaction encoder) and one decoder (future decoder). The history encoder (i.e., the RNN encoder 116 at step 104), implemented with an RNN, extracts an individual vehicle's dynamics from its historical trajectory. The interaction encoder (i.e., the GNN encoder 124 at step 108) uses a GNN to summarize interaction features among a variable number of vehicles. Then the future decoder (i.e., the RNN decoder 128 at step 110) uses another RNN to roll out the future trajectory of the target vehicle. Details of these main parts of the proposed model are described below.

At step 104, the history RNN encoder 116 is shared across all vehicles to encode individual dynamics from their own historical trajectories. The following equation shows that the RNN encoder 116 is applied to historical tracks of all vehicles in parallel.

Rₜ={rₜ⁰,rₜ¹, . . . ,rₜ^{m}}=RNNₕᵢₛₜ (Emb( [symbol] ))

where Emb( ) is a linear transformation embedding low-dimensional xy-coordinates into a high-dimensional vector space, RNNₕᵢₛₜ is a shared RNN applied to the embedded historical tracks of all vehicles, rₜⁱ is the dynamics feature of vehicle i at time t.

Considering the fact that driving is an interactive activity and the mutual influence between two cars on each other is different, the method 100 at step 106 models the inter-vehicular interaction as a directed graph 132, where each node represents a vehicle and contains the vehicle's sequential feature.

The directed graph 132 is defined as a graph can be represented by [symbol] =(V, E), where V={v₀, . . . , vₘ} is the set of m+1 nodes, and E⊂V×V is the set of edges. If the edge from node i to node j is different from the edge from node j to node i, the graph is a directed graph.

Since the present disclosure models the interaction among vehicles as a graph, the structure of the graph will significantly affect the performance and efficiency of the method 100. If the graph contains only self-connections, its performance should be similar to a simple model embodiment of the present invention on the target vehicle's historical track only. While if the graph contains all connections (i.e., every node is connected to the rest of the nodes), it considers redundant connections, which increases quadratically with the number of nodes. The present methods consider up-to-eight neighbouring vehicles and, in some embodiments, construct the interactive graph as a star-like graph.

Without loss of generality, a target vehicle is set as v₀, and all the neighboring vehicles as {v₁, . . . , vₘ}. Then the edge set of the star-like graph with self-loop is constructed.

E={e^{0,j}}(j=0, . . . ,m)∪{e^{j,0}}(j=1, . . . ,m),

where e^{i,j} means that there is a directed edge from node j to node i, that is, node j is the neighbor of node i and node j's behavior will affect node i's behavior. An example of the star-like directed graph with self-loop can be found in graph 132 shown in FIG. 1.

At step 108, nodes in the constructed graph contain corresponding vehicles' sequential features rₜⁱ and directed edges represent their directed effects to others. Then the graph is processed by a graph neural network to model the interaction feature gₜ⁰∈Gₜ as shown in the following equation

Gₜ=GNNᵢₙₜₑᵣ(Rₜ,Eₜ),

where Eₜ represents the graph structure at time t, GNNᵢₙₜₑᵣ is the interaction encoder 118 implemented with a 2-layer GNN, and Gₜ={gₜ⁰, . . . , gₜ^{m}} contains the interaction features of all vehicles at time t.

At step 110, the future trajectory fₜ⁰ is predicted upon the target vehicle's dynamics feature rₜ⁰ and interaction feature gₜ⁰ using another RNN.

ₜ⁰=RNN_{fut}([gₜ⁰,rₜ⁰]),

where RNN_{fut} is the future decoder 128 implemented with RNN and [gₜ⁰, rₜ⁰] is the concatenation of gₜ⁰ and rₜ⁰. In one embodiment as shown in FIG. 1, the RNN decoder is an LSTM decoder. The model also uses proper fully-connected layers, which are not shown in the equations.

The present disclosure now illustrates the experiments. The experiments are set up with data pre-processing, model implementing, and metric setting. Vehicle trajectories are extracted from the publicly available NGSIM US-101 dataset, collected from 7:50 a.m. to 8:35 a.m. on Jun. 15, 2005, for training and validation. The study area is a 640 meters segment of U.S. Highway 101, consisting of five main lanes, one auxiliary lane, and on-ramp and off-ramp lanes. The vehicle trajectory data are recorded at 10 Hz using eight synchronized digital video cameras mounted from the top of a 36-story building. A roughly balanced set of data were selected so that trajectories that keep to their lanes do not dominate the dataset.

The present disclosure now discusses data pre-processing part of the experiments. A target vehicles is first selected and then data pieces from the trajectory of that vehicle are selected. In some embodiments, a vehicle is selected as a target vehicle upon following conditions. First, it has not been driven in lanes 7 (on-ramp) and 8 (off-ramp). Second, it only changed its lane once during the recording time. Third, its recorded track is at least 1,000 feet in length. Fourth, the lane-change manoeuvre happened within the range from 300 to 1,900 feet in the study area. Fifth, the lane-change manoeuvre was obvious—the maximum lateral displacement before and after lane-change is greater than 10 feet.

This step also involves selecting 124 (out of 1,993) vehicles from the 07:50 am-08:05 am segment, 106 (out of 1,533) vehicles from the 08:05 am-08:20 am segment, and 68 (out of 1,298) vehicles from the 08:20 am-08:35 am segment.

Regarding data selection, for a target vehicle, 260 frames from 13 seconds (130 frames) before lane-change to 13 seconds (130 frames) after lane-change are considered as candidates of the current frame. Then the data is stored in the dataset if the following conditions are all satisfied. The conditions include: 1) the target vehicle has a 3-second historical trajectory and a 5-second future trajectory; and 2) all neighbouring vehicles have a 3-second historical trajectory.

This step selects totally 63,176 pieces of data with 23,803 from the 07: 50 am-08:05 am segment, 24,559 from the 08:05 am-08:20 am segment, and 14,814 from the 08:20 am 08:35 am segment.

Regarding translation, a stationary frame of reference with its origin fixed at the target vehicle's current position is used for each data piece.

Regarding down-sampling, the raw data in NGSIM US-101 is recorded with a sampling rate of 10 Hz. The historical tracks are down-sampled by a factor of 2 and the future trajectories by 5.

Regarding edge indexes, the edge set representing the graph structure is constructed as described below. Considering the fact that driving is an interactive activity and the mutual influence between two cars on each other is different, the method 100 at step 106 models the inter-vehicular interaction as a directed graph 132, where each node represents a vehicle and contains the vehicle's sequential feature.

Regarding data format, a data with 3 parts is stored to the dataset.

data={ [symbol] ,Eₜ,yₜ}

where [symbol] is the historical tracks of all vehicles, Eₜ is the edge set containing the structure of the interactive graph, and yₜ is the target vehicle's ground truth future trajectory.

After the above processing, the present invention randomly selects 10,000 data pieces from the whole dataset as the validation set and uses the rest of the dataset for training.

All the models in presently proposed are implemented with PyTorch except for the GNN layers. The GNN layers are implemented with PyTorch Geometric. The history encoder is implemented using a one-layer Gated Recurrent Unit (GRU) with a 32-dimensional hidden state, and the future decoder is implemented using a two-layer LSTM with a 64-dimensional hidden state. The interaction encoder is implemented with two Graph attention network (GAT) layers, which adopt concatenated three-head attention mechanism to stabilize the training process. Other numbers of attention network layers may be used—e.g. one, or three or more—as necessary. Embodiments of the present invention use LeakyReLU with a 0.1 negative slope as the only activation function, though other activation functions are possible.

The proposed model is trained for 50 epochs to minimize the same loss function using Adam (i.e. Adaptive Moment Estimation) with a learning rate of 0.001. Other adaptive learning rate optimisation algorithms can be used, such as stochastic gradient descent. Similarly, other learning rates may be used such as 0.01, to increase the learning rate. The learning rate can be varied based on a trade-off between speed of convergence and removal of the effects of outliers, to increase or decrease recency bias and can also be changed over time.

The root-mean-square error (RMSE) in meters of the predicted trajectories against the ground truth future trajectories is used to evaluate different models. RMSE is calculated for each predictive time step tₚ within 5 seconds in the future.

$$R M S E ( {t}_{p} ) = \sqrt{\frac{1}{n} {\sum }_{i = 1}^{n} ( {( {\hat{x}}_{{t}_{p}}^{i} - {x}_{{t}_{p}}^{i} )}^{2} + {( {\hat{y}}_{{t}_{p}}^{i} - {y}_{{t}_{p}}^{i} )}^{2} )}$$

where n=10000 is the size of test set, (\hat{x}ₜ_{ₚ}^{t}, ŷₜ_{ₚ}ⁱ) and (xₜ_{ₚ}ⁱ, yₜ_{ₚ}ⁱ) are the predicted position of the target vehicle in data i at time tₚ and the corresponding ground truth, respectively. It will be understood that RMSE is one of many options, such as other employing formulae reflective of the Euclidean distance of output against ground truth, and other error formulae using a probability density function.

When comparing single trajectory prediction, one comparison method is called dynamics-only. Dynamics only is a one-channel ablation of the proposed model considering the target vehicle's dynamics feature only for prediction. Another comparison method is interaction-only. Interaction only is also a one-channel ablation using only the interaction feature extracted by the GNN. The third method is called two-channel, which is the proposed two-channel model. The above implementations are trained and validated using the same dataset.

The comparison results are listed in Table 1.

TABLE 1

| | | Prediction horizon | | | | |
|---|---|---|---|---|---|---|
| | Methods | 1 sec | 2 sec | 3 sec | 4 sec | 5 sec |
| 1 | Dynamics-only (Ours) | 0.74 | 1.86 | 3.30 | 5.07 | 7.11 |
| 2 | Interaction-only (Ours) | 0.67 | 1.03 | 1.34 | 1.74 | 2.46 |
| 3 | Two-channel (Ours) | 0.68 | 0.99 | 1.21 | 1.53 | 2.14 |
| 4 | CS-LSTM | 0.61 | 1.27 | 2.09 | 3.10 | 4.37 |
| 5 | GRIP | 0.37 | 0.86 | 1.45 | 2.21 | 3.16 |
| 6 | CNN-LSTM | 0.64 | 0.96 | 1.22 | 1.53 | 2.09 |

Table 1 shows that interaction-aware methods (2,3,4,5,6) outperform the dynamics-only method (1). This confirms the desirability of modelling interactions for trajectory prediction. Table 1 also shows that the proposed two-channel model outperforms its interaction-only ablation. This shows that the target vehicle's dynamics feature should be emphasized for trajectory prediction. The present disclosure sets an additional channel for that purpose.

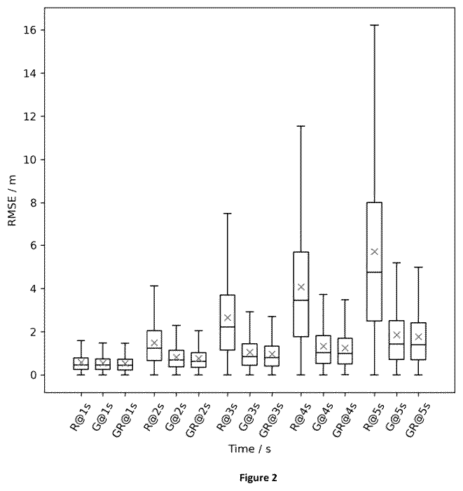

FIG. 2 shows box plots of the RMSE errors of models implemented in this study over a 5-second time in the future, where, at each time step, the first box (R@1s, R@2s, R@3s, R@4s, R@5s) is the result of the dynamics-only model (R), the second box (G@1s, G@2s, G@3s, G@4s) is the result of the interaction-model (G), and the third box the result of the proposed two-channel model (GR@1s, GR@2s, GR@3s, GR@4s)). A cross in a box represents its mean value. Outliers are ignored for clarity. In addition to Table 1, FIG. 2 shows that the prediction of interaction-aware methods (G & GR) is more stable (shorter interquartile range (IQR)) than a dynamics-only model (R) and the proposed two channel model produces the shortest IQR. Please note that the mean value shown in FIG. 2 is calculated using the following equation:

$$R M S E ( {t}_{p} ) = \frac{1}{n} {\sum }_{i = 1}^{n} \sqrt{{( {\hat{x}}_{{t}_{p}}^{i} - {x}_{{t}_{p}}^{i} )}^{2} + {( {\hat{y}}_{{t}_{p}}^{i} - {y}_{{t}_{p}}^{i} )}^{2}}$$

which is slightly different to the results in Table 1.

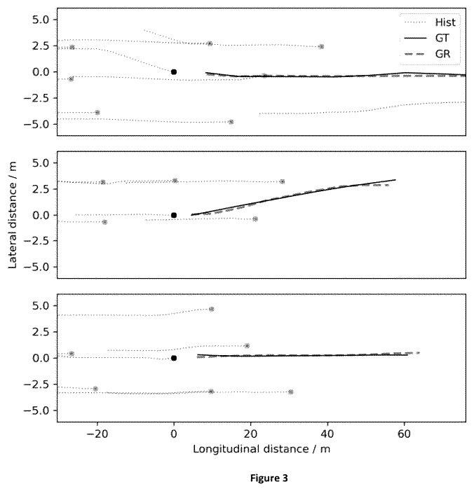

FIG. 3 visualizes prediction results in situations with different numbers of surrounding vehicles from the validation set. Squares are the considered vehicles (target vehicle in black and neighbouring vehicles in grey). Dotted lines are the historical tracks of respective vehicles over the preceding 3 second period. The solid line in each case is the ground truth (GT) future trajectory of the target vehicle. The dashed line is the prediction of the proposed two-channel model (GR). All the vehicles move from left to right. It shows that the proposed model can predict the target vehicle is going to keep or change lane in the next 5 seconds regardless of how many surrounding vehicles are in sight.

Even though the present methodologies focus on single trajectory prediction, the proposed model has the potential to be applied to multi-vehicular trajectory prediction since the interaction encoder implemented with GNN processes all nodes simultaneously.

From the point of view of the target vehicle, multi-vehicular trajectory prediction (MTP) is used. MTP endeavours to predict future trajectories of up-to-eight target vehicles based on historical tracks of more vehicles. In this formulation, considered vehicles are separated into three categories: one target vehicle, up-to-eight target vehicles, and some other surrounding vehicles. The MTP problem here is formulated as discussed before and the target vehicles are selected as the selection of neighbouring vehicle. The input to the model is the historical trajectories of all considered vehicles,

[symbol]

+={hₜ⁰,hₜ¹, . . . ,hₜ^{m},hₜ^{m+1}, . . . ,hₜⁿ}

where the hₜ⁰ is the historical track of the ego vehicle (i.e. vehicle in question) and 1≤m≤8 is the number of target vehicles (i.e. surrounding vehicles). MTP simultaneously predicts m target vehicles' future trajectories, numbered from 1 to m, based on historical trajectories of n+1 vehicles.

The output is then the predicted future trajectories of the vehicles:

[symbol]

={fₜ¹,fₜ², . . . ,fₜ^{m}}

where fₜⁱ=[pₜ₊₁ⁱ, pₜ₊₂ⁱ, . . . , p_{i+T}_{_{f}}ⁱ] represents the sequence of future trajectory of vehicle i at time t.

The dataset used here is pre-processed from the 08:05 am to 08:20 am segment of NGSIM US-101. The size of training and validation datasets are 533,564 and 13,3392, respectively.

Table 2 compares the proposed method with a previous concept on the MTP task. It shows that the proposed model, when applied to multi-vehicular trajectory prediction, matches the previous concept 1 in terms of RMSE.

TABLE 2

| | | Prediction horizon | | | | |
|---|---|---|---|---|---|---|
| | Methods | 1 sec | 2 sec | 3 sec | 4 sec | 5 sec |
| 1 | Two-channel (Ours) | 0.54 | 1.12 | 1.80 | 2.63 | 3.67 |
| 2 | Previous concept 1 | 0.64 | 1.13 | 1.80 | 2.62 | 3.60 |

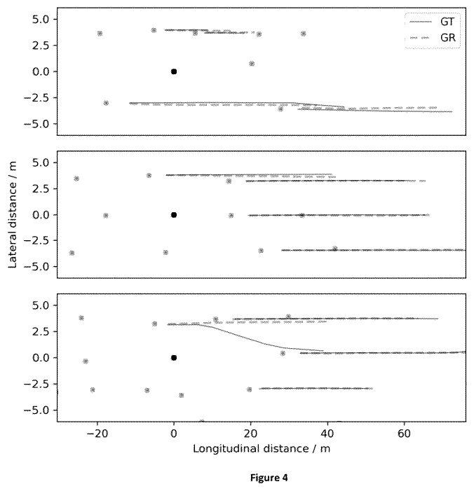

FIG. 4 visualizes the prediction results of the proposed model on the MTP task. Black square is the target vehicle and grey squares represent the rest of considered vehicles. Only future trajectories of four target vehicles are plotted for clarity. Solid grey lines are the ground truth and dashed grey lines are the predictions of future trajectories. All the vehicles move from left to right. It can be seen that the proposed method can predict the multiple trajectories longitudinally while it fails to predict the lane-change maneuver in the next 5 seconds. This can be explained by the imbalance of the MTP dataset since the majority of the future trajectories in the dataset are keeping lane, and it is hard to get a roughly balanced dataset for MTP.

In general, the present methodologies propose a GNN-RNN-based method for trajectory prediction to model the inter-vehicular interaction among various vehicles. RNN is used to capture the dynamics feature of vehicles, and GNN is adopted to summarize the interaction feature. Another RNN serves as the decoder jointly considers the dynamics and interaction feature for prediction. In experimentation, it was determined that both the target vehicle's individual dynamics feature and its interaction with other vehicles affect the prediction accuracy. The proposed method matches state-of-the-art methods on the NGSIM dataset in terms of RMSE.

As previously discussed, some embodiments disclosed herein can be adapted to handle multi-vehicular trajectory prediction properly by considering each individual vehicle as the target vehicle, given each vehicle's trajectory is processed simultaneously. This can be useful for downstream decision-making for autonomous driving. It can also be extended to consider the multi-modality of driving behaviours.

To adapt the proposed GNN-based deep learning method to multi-model trajectory prediction and to address the limitations of Goal-Net, a map-adaptive multi-modal trajectory predictor is proposed. The map-adaptive multi-modal trajectory predictor can predict single centre-line guided, cross centre-line, and motion-based trajectories of a target agent simultaneously in an integrated manner.

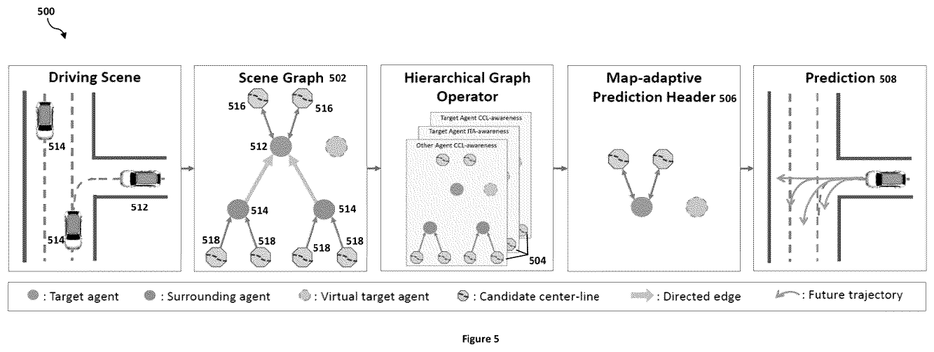

A high-level architecture is introduced for the proposed map-adaptive multi-modal trajectory predictor, and the method it employs is shown in FIG. 5. FIG. 5 illustrates an example method 500 of determining a predicted trajectory of a moving object. The predictor takes as input the historical states of multiple agents and their candidate centre-lines (CCLs) retrieved from the HD-map then outputs a variable number of possible future trajectories of a target agent. The number of predictions depends on the number of the target agent's CCLs. Given the input (driving scene), the present framework first represents the input as a heterogeneous hierarchical graph (scene graph). Then it encodes the scene graph with a hierarchical graph operator. Next, it applies a map-adaptive prediction header for multi-modality. Finally, a shared decoder is applied to all modalities to produce the final trajectories.

As shown in FIG. 5, a given driving scene consists of agents and the HD-map. A variable number of candidate centre-lines are assigned to each agent according to the dynamics of the respective agent and the road structure. Then, the driving scene 501 is represented with a heterogeneous hierarchical graph (scene graph 502). Each node can be either an agent or its candidate centre-line, with an additional virtual target agent node. Next, the scene graph is processed using the proposed hierarchical graph operator 504. Finally a map-adaptive prediction header 506 is applied to predict a variable number of trajectories. These predictions 508 of a target agent fall into three categories namely single-CCL, cross-CCL, and motion-based predictions. The method 500 thus comprises:
obtaining historical trajectory data for the moving object and for one or more neighbouring objects;
passing the historical trajectory data to a RNN encoder to generate dynamic features for the moving object and the one or more neighbouring objects;
constructing a graph representing interactions between the moving object and the one or more neighbouring objects, wherein each node of the graph represents one of the moving object or one of neighbouring objects, and comprises the respective dynamic features of the moving object or the one or more neighbouring objects, and each edge represents an effect of the moving object on a neighbouring object or vice versa, or an effect of a neighbouring object on another neighbouring object;
passing the graph and the dynamic features to a GNN encoder to generate a plurality of interaction features; and
passing the dynamic features and the interaction features to a RNN decoder to generate the predicted trajectory.

The method 500 aims to predict a set of multimodal trajectories of a target agent 512 given agents' dynamics and the local map. At a time t, the input Xₜ contains historical states of considered agents and their CCLs 516/518:

Xₜ=[ [symbol] , [symbol] ]

where [symbol] ={hₜ¹, hₜ², . . . , hₜⁿ} contains the historical states of n agents

$${at}_{n , m - 1}$$

time t and [symbol] ={cₜ^{1,1}, cₜ^{1,2}, . . . , cₜ^{2,1}, cₜ^{2,2}, . . . , cₜ^{n,m-1}, cₜ^{n,m}} contains the CCLs of each agent. hₜⁱ=[s_{t-T}_{ₕ}₊₁ⁱ, s_{t-T}_{ₕ}₊₂ⁱ, . . . , sₜⁱ] is the historical states of agent i over a traceback horizon Tₕ, where sₜⁱ=[xₜⁱ, yₜⁱ, vₓₜⁱ, v_{yt}ⁱ] is the states (position and velocity) of the agent i at time t·cₜ^{i,j}=[(x, y)₁^{i,j}, (x, y)₂^{i,j}, . . . , (x, y)₂₀^{i,j}] is the jₜₕ CCL of agent i at time t that contains 20 way-points. The number of considered agents n and the number of CCLs of an agent m vary from case to case. The output is a set of trajectories of the target agent:

[symbol]

={fₜ¹,fₜ², . . . ,fₜ^{m},fₜ^{m+1},fₜ^{m+2}}

where fₜ^{j}=[(xₜ₊₁^{j}, yₜ₊₁^{j}), . . . , (x_{t+T}_{_{f}}^{j}, y_{t+T}_{_{f}})] is jₜₕ sequence of predicted XY-coordinates of the target agent over a prediction horizon T_{f}. The first m predictions are based the target agent's m CCLs. fₜ^{m+1} is the cross-CCL prediction and fₜ^{m+2} is the motion-based prediction.

Given the agents 512/514 and their CCLs 516/518, their relationships are represented by a heterogeneous hierarchical scene graph 502. A node in the graph 502 is either an agent 512/514 or a CCL 516/518 of an agent. To keep the connection sparse, CCL nodes 516/518 of an agent are only connected to the agent node itself, and all the surrounding agents 514 are only connected to the target agent node 512. Each raw node feature is first processed by a corresponding RNN. Then an agent node contains its dynamics feature, and a CCL node contains its sequential feature accordingly. A virtual target node is introduced into the graph to preserve the dynamics feature of the target agent from graph operation for motion-based prediction.

Regarding hierarchical graph operator, a three-stage graph operator 504 is designed, employing information flow regulation, to encode the scene graph. The information flow is regulated by an edge-masking technology that masks out certain edges in the graph before graph operation. The first stage lets information flows from surrounding agents' CCLs 518 to the surrounding agents 514. The second stage lets information flow form surrounding agents 514 to the target agent 512. The third stage lets the target agent 512 to collect information of its CCLs 516. These stages are implemented by applying a graph operator on the graph with masked edge indexes. After this operation, the target agent node 512 collects information about its surrounding agents 514 and its own options.

For multi-modal prediction, a variable number of future trajectories of a target agent 512 are predicted according to the CCLs 516 of the target agent. This is realized via graph representation and operation. In addition to CCL-based predictions, the map-adaptive predictor 506 also produces a motion-based prediction concurrently to cover corner-cases. The motion-based prediction is integrated into the graph representation and operation by introducing a virtual target node into the graph representation. Excepting adding a virtual target node into the graph, no further operations is needed for motion-based prediction. This is because of the parallelism of graph neural networks.

To illustrate the proposed CCL-guided trajectory prediction method the driving context is first represented as a heterogeneous hierarchical graph. This involves representing the driving scene context as a heterogeneous hierarchical graph, where the nodes and edges fall into different categories. The hierarchical graph contains two layers, where the lower layer is the agent-CCL graph and the upper layer is the inter-agent interaction graph. The agent-CCL graph is a star-like graph with the agent at the centre and all the agent's CCLs linked to the centre (indicated by deep grey arrows in the second block of FIG. 5. The interaction graph is another star-like graph with the target agent at the centre and all neighbouring nodes linked to the target agent node (indicated by light grey arrows in the second block of FIG. 5. In addition to the objects in the driving scene, a virtual target agent node is introduced (light green node with dashed edges in the second block of FIG. 5) for the purpose of motion-based prediction. The virtual node is isolated in the graph and has no CCL nodes to form a sub-graph. The present disclosure also assumes that each node in the graph has a self-loop for information preservation. But, for clarity, these self-loops are not plotted. The graph contains a plurality of kinds of nodes and edges—presently four kinds of nodes though greater or fewer than four can be provided, depending on the driving scenario.

There are many advantages of this representation. First, the graph representation can accommodate an arbitrary number of objects. Second, the heterogeneous graph can comprehensively represent different kinds of objects. Third, the star-like graph structure is sparse, so that it is more efficient comparing to graphs with dense connectivity. Fourth, the hierarchical structure allows information flow from local to global. Fifth, the introduced virtual node preserves the target agent's dynamics for motion-based prediction.

The Argoverse dataset provides center-line segments and their connectivity. It also provides a map API (Application Programming Interface) to interact with the HD-map. With this API, the CCLs of a given trajectory can be obtained.

TABLE 3

| | |
|---|---|
| TarAg | Target agent node |
| VirTarAg | Virtual target agent node |
| NbrAg | Neighbor agent node |
| TarCCL | Target agent's CCL node |
| NbrCCL | Neighbor agent's CCL node |
| TarAg-Loop | Self-loop of the TarAg node |
| VirTarAg-Loop | Self-loop of the VirTarAg node |
| NbrAg-Loop | Self-loop of the NbrAg node |
| TarCCL-Loop | Self-loop of the TarCCL node |
| VirTarAg-Loop | Self-loop of the NbrCCL node |
| NbrCCL → NbrAg | Edge from NbrCCL node to NbrAg node |
| NbrAg → TarAg | Edge from NbrAg node to TarAg node |
| TarCCL → TarAg | Edge from TarCCL node to TarAg node |

Embodiments of the present invention involve constructing a heterogeneous hierarchical graph to represent the interaction among agents and CCLs. The graph contains a plurality of types of objects (presently two types—agent and CCL). The objects are further divided into four (or other, as mentioned above) types of nodes (target agent 512, other agent 514, target agent's CCL 516, and other agent's CCL 518). In addition to these nodes, embodiments introduce a virtual target node in the constructed graph to integrate motion-based prediction. For an agent node, the raw node feature is the agent's historical states. For a CCL node, the raw node feature is a sequence of XY-coordinates of this CCL. A directed edge pointing from node j to node i means that node j has impact on node i and there will be information flow from node j to node i. An edge is associated with an edge type that is determined by the source node and target node of the edge. The edge set is represented as:

E={eᵢⱼ}(j∈ [symbol] ), i=1, . . . , N,

where eᵢⱼ is a directed edge from node j (the source node) to node i (the target node), [symbol] is the neighborhood of node i, and N is the number of nodes in the graph. Self-loops eᵢᵢ are included in the edge set. An example of the constructed graph is shown in the second block of FIG. 5. Table 3 shows the node and edge types in this heterogeneous hierarchical graph.

To handle heterogeneous edges in the graph, the present methodologies design edge-masking. The particular technique applies a mask on the edges of graph before processing the graph with a GNN. Edge-masking selects a subset of edges (can be of different types) from the entire graph. This allows regulation of information flow from nodes to nodes (can be of different types). This is different from HetGNN, which applies a GNN for each type of edge connection. With edgemasking, only one edge set with several edge masks is saved for each graph operator.

Since there are two kinds of objects in the scene graph 502, i.e., vehicles and their candidate CCLs, one shared encoder is used for each type. The CCLs are assumed to be sequences of X-Y coordinates and the historical states of vehicles are sequences of their position and velocity over the preceding (most recent) two seconds. All coordinates are defined in the target-centred coordinate framework with its origin fixed at the target agent's current position and its horizontal axis aligning to the target agent's current heading direction.

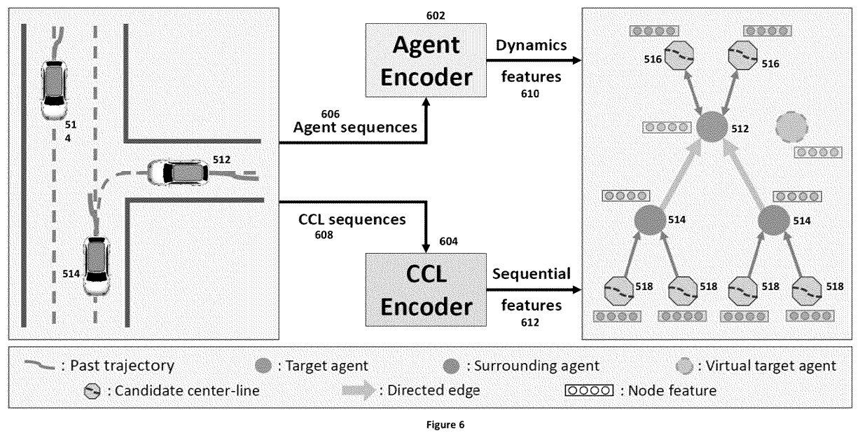

FIG. 6 provides an illustration of the sequence encoding. To illustrate the agent dynamics encoder 602, an agent is represented by a sequence of its historical states (see agent sequences 608). A gated recurrent unit (GRU) network models the agent dynamics from historical states of the agent:

rₜⁱ=GRU_{agn}(hₜⁱ)

where hₜⁱ is the historical sequence of vehicle node i at time t, GRU_{agn} is the GRU network for agents dynamics encoding, and rₜⁱ is is the extracted temporal feature (see 610 in FIG. 6)

To employ the candidate centre-line (CCL) encoder 604, a CCL is represented by a sequence of XY-coordinates (see CCL sequences 608). Another GRU network models the sequential dependencies of a centre-line sequence:

rₜ^{j}=GRU_{ccl}(cₜ^{j})

where cₜ^{j} is the way-point sequence of CCL j at time t, GRU_{ccl} is the GRU network for center-line encoding, and rₜ^{j} is is the extracted sequential feature (see 612 in FIG. 6). Then the extracted features Rₜ={rₜ¹, rₜ², . . . , rₜⁱ, rₜ^{j}, . . . , rₜ^{N-1}, rₜⁿ} are taken as node features of the scene graph. In particular, as shown in FIG. 6, given the agents' historical states and candidates CCLs, the present methodology applies the agent encoder and CCL encoder to extract sequential dependence in corresponding sequences. The extracted features can be taken as node features of the scene graph 502.

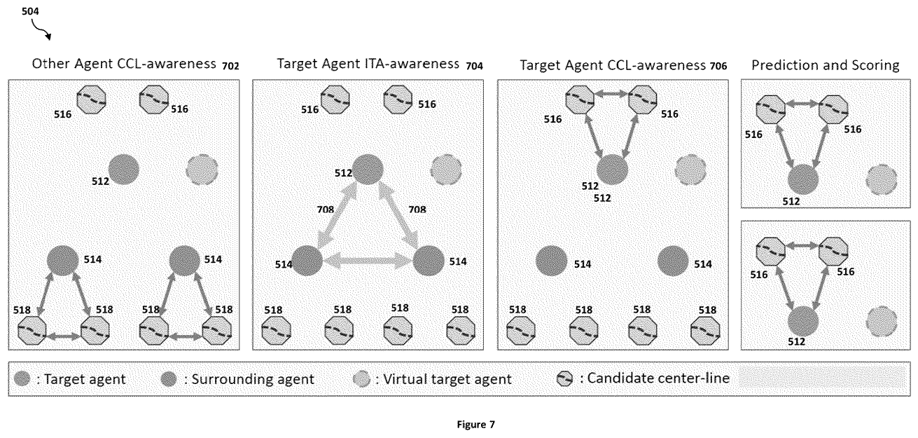

With reference to FIG. 7, the scene graph 502 is then encoded using a hierarchical graph operator (HGO) 504. The HGO 504 comprises a plurality of stages, presently three stages namely 1) surrounding agents' CCL awareness 702, 2) target agent's interaction awareness 704, and 3) target agent's CCL awareness 706. The first stage 702 allows the surrounding agents 514 to gather information from their CCLs. The second stage 704 then allows the target agent 512 to model its interaction 708 with the surrounding agents 514. The third stage 706 then brings CCL-awareness to the target agent 512. Each stage is implemented with a separate GRU with information flow regulated by the edge-masking technology. The information flow in HGO is shown in FIG. 7.

GAT is utilized to implement the graph operators in each proposed method, directed at modelling the effects of a target vehicle's surrounding agents and candidate centre-lines on its future motion and representing the relationship as a graph. GNNs can be used to apply neural networks to the graph learning tasks. GAT is selected since it operates on a local neighbourhood and its attention mechanism allows to model the importance of different factors. However, other attention networks for detecting one or both of Bahdanau and Luong attention can be employed without departing from the present teachings.

For a node i, a GAT layer first computes attention coefficients over its neighbourhood, using a LeakyReLU activation function between layers:

$${α}_{i j} = \frac{exp ( LeakeyReLU ( {\vec{a}}^{T} [ W {\vec{h}}_{i} ‖ W {\vec{h}}_{j} ] ) )}{{Σ}_{k ∈ {𝒩}_{i}} exp ( LeakeyReLU ( {\vec{a}}^{T} [ W {\vec{h}}_{i} ‖ W {\vec{h}}_{k} ] ) )}$$

where \vec{h}ᵢ is the node feature of node i, \vec{h}ⱼ is the node feature of node i's neighbouring node j, W is a shared linear transformation applied to every node, \vec{a}^{T} is an attention mechanism implemented with a single-layer fully-connected network, LeakeyReLU is the used nonlinearity, and [symbol] is the neighborhood of node i. Then it updates feature of node i via a linear combination of features of neighboring nodes according to the normalized attention coefficients:

$${\vec{h}}_{i}^{′} = σ ( {\sum }_{j ∈ {𝒩}_{i}} {α}_{i j} {W}_{h} {\vec{h}}_{i} )$$

where Wₕ is the linear transformation matrix and σ is the sigmoid function. Please note that GAT also supports multi-head attention for learning stabilization.

Before modelling interactions between the target and its surrounding agents to model surrounding agents' CCL awareness 702, the surrounding agents gather information from their own candidate centre-lines (CCLs). This operation, when modelling inter-agent interactions in the following stage, gives the target agent a broader view of the road structure and possible motions of its surrounding agents. A GAT is then applied to the entire graph with edge-masking to regulate information flow in this graph operation, so that the information only flows from surrounding agents' CCL nodes to themselves:

Gₜ¹=GAT₁(Rₜ,E₁)

where Rₜ contains node features for both agent and CLL nodes, E₁ is the edge set retrieved for this stage via masking, GAT₁ is the GAT for this stage, and Gₜ¹ is the output of this stage. Each surrounding agent node in Gₜ¹ is with CCLawareness. All the other nodes, i.e., the target, the virtual target, and all the centre-line nodes, remain isolated. The information flow regulated by edge-masking is shown in the first block of FIG. 7. Specifically, the edges of the following types are used in this graph operator: {NbrCCL→NbrAg, TarAg-Loop, NbrAg-Loop, TarCCL-Loop, VirTarAg-Loop}.

In the second stage (interaction awareness) 704, the target agent gathers information from its neighbourhood. The neighbouring agents are aware of their corresponding CCLs, this stage provides interaction awareness to the target vehicle along with further road awareness from its neighbours:

Gₜ²=GAT₂(Gₜ¹,E₂)

where Gₜ¹ is the output of Eq. 8. E₂ is the edge set retrieved for this stage via masking, GAT₂ is the GAT for this stage, and Gₜ² is the output of this stage. This stage brings interaction awareness to the target agent node. All the other nodes, i.e., the surrounding agents, the virtual target, and all the CCL nodes, remain isolated. The information flow regulated by edge-masking is shown in the second block 704 of FIG. 7. Various edge types can be used, of which FIG. 7 shows the following types for this stage: {NbrAg→TarAg, TarAg-Loop, NbrAg-Loop, TarCCL-Loop, VirTarAg-Loop}.

The third stage is to make the target agent to be aware-of its options (per target vehicle awareness 706). The options for the target agent are represented by its candidate center-lines (CCLs):

Gₜ³=GAT₃(Gₜ²,E₃)

where Gₜ² is the output of the last equation. E₃ is the edge set retrieved for this stage via masking, GAT₃ is the GAT for this stage, and Gₜ³ is the output of this stage. This stage lets the target agent to look at its CCLs with knowledge of surrounding agents' options and interactions. All the other nodes, i.e., the surrounding agents, the virtual target, and all the CCL nodes, remain isolated. The information flow regulated by edge-masking is shown in the third block of FIG. 7. Specifically, the edges of the following types are used in this stage: {TarCCL→TarAg, TarAg-Loop, TarCCL-Loop, VirTarAg-Loop}.

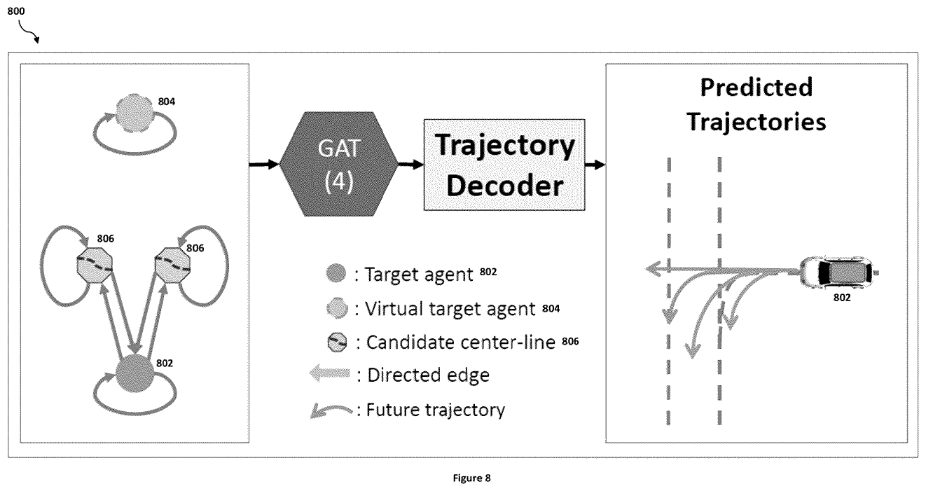

To determine possible trajectories for the target agent, a candidate centre-lines guided predictor 800 is then formulated as shown in FIG. 8. The present candidate centre-lines guided predictor 800 involves utilizing a variable number of CCLs to predict a plurality, and presently three, kinds of future trajectories of a vehicle of interest. The number of CCLs depends on the lane geometry of the driving scene, and the predicted trajectories include single centre-line based, cross centre-line based, and motion-based predictions. This design is based on the following observations. First, the road structure mainly shapes the motion of vehicles, and the vehicles are tend to follow centre-lines when driving to keep safe distance with each other. Second, there are some situations where a vehicle will drive along a combination of two or more centre-lines. Third, the motion of a vehicle can purely depend on its own dynamics in some corner-cases.

To handle the variable number of CCLs, the predictor uses graph representation and graph neural network. After encoding, a GAT is applied on the graph with edges. This distributes the target agent feature to the CCL nodes and let the target agent node have an overall understanding of its options (CCLs). A trajectory decoder is then applied to output the final multi-modal prediction. The graph structure used by this predictor is shown in the left block of FIG. 8, that illustrates a heterogeneous graph containing three types of nodes: a target node 802, a virtual target node 804, and a set of CCL nodes 806 of the target vehicle 802. The graph structure is also obtained via edge-masking technology. Throughout all the previous encoding stages with the present information flow regulation strategy, the node features are updated and contain corresponding features for three types of predictions. The target node contains overall information of the scene. The virtual target node 804 contains its own dynamics. The target vehicle's CCL nodes 806 contain corresponding CCL features. Since present focus is on the target agent 802, all other agents and their CCL nodes are ignored in this part. Let m be the number of the target vehicle's CCLs, the predictor will output m+2 predictions:

Fₜ=MLP_{pred}(GAT_{pred}(Gₜ³,E₄), Maskₜₐᵣ)

where Gₜ³ is the output of the last equation, E₄ is the edge set retrieved for this stage via masking, GAT_{pred} is the GAT used for prediction, Mask_tar is used to select the target agent node and the target CCL nodes from the output of GAT_{pred}, MLP_{pred} is the trajectory decoder implemented with a multi-layer perceptron, and Fₜ is the predicted future trajectories of the target agent. Fₜ contains m single center-line predictions, one cross center-line prediction, and one motion-based prediction. Specifically, the edges of the following types are used in this graph operator: {TarCCL→TarAg, TarAg→TarCCL, TarAg-Loop, TarCCL-Loop, VirTarAg-Loop}.

Multiple-Trajectory Prediction (MTP) loss or modified MTP loss is proposed to train the map-adaptive prediction framework in an end-to-end way. The modified MTP loss takes as an input a set of predicted trajectories and one ground truth trajectory of the target agent. Unlike the original MTP loss, modified MTP loss focuses on minimizing regression loss. It first selects the predicted trajectory with the smallest average L2 distance to the ground truth as the best mode, then calculates the smoothed L1 loss between the best prediction and the ground truth trajectory.

The present multi-trajectory prediction method is able to predict a variable number of trajectories of a target agent according to CCLs. The present methods are able to simultaneously predict three (or other number) types of trajectories and the prediction number is adaptive to the number of CCLs.

In the present disclosure, a map-adaptive multi-modal trajectory prediction framework is proposed that can predict single centreline guided, cross centre-line, and motion-based trajectories of an agent in an integrated manner. The driving scene is represented using a heterogeneous hierarchical graph and a hierarchical graph operator is designed with an edge-masking technology to encode the driving scene. In addition to map-compliant predictions, the present method also considers the corner-case where a vehicle's future motion purely depends on its own motion. Considering this crucial corner-case is important for the safety of an autonomous vehicle.

Also disclosed is a system for determining a predicted trajectory of a moving object, which can be one of many moving objects and the method may be applied to determine trajectories of more than one of those objects and/or more than one trajectory for each object. The system comprises memory; and at least one processor in communication with the memory. The memory stores machine-readable instructions for causing the at least one processor to:
receive historical trajectory data for the moving object and for one or more neighbouring objects;
pass the historical trajectory data to a recurrent neural network (RNN) encoder to generate dynamic features for the moving object and the one or more neighbouring objects;
construct a graph representing interactions between the moving object and the one or more neighbouring objects, wherein each node of the graph represents either the moving object or one of neighbouring objects, and comprises the respective dynamic features of moving object or said one of the neighbouring objects, and each edge represents an effect of the moving object on a neighbouring object or vice versa, or an effect of a neighbouring object on another neighbouring object;
pass the graph and the dynamic features to a graph neural network (GNN) encoder to generate a plurality of interaction features; and
pass the dynamic features and the interaction features to a RNN decoder to generate the predicted trajectory.

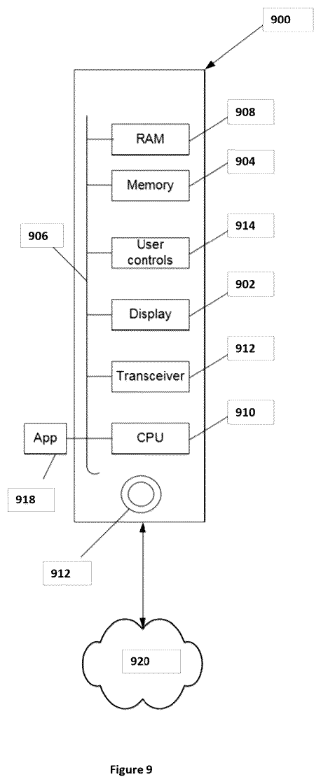

FIG. 9 is a block diagram showing an exemplary computer device 900, in which embodiments of the invention may be practiced. The computer device 900 may be a mobile computer device such as a smart phone, a wearable device, a palm-top computer, and multimedia Internet enabled cellular telephones when used in training the model, and, for use in controlling a vehicle or other machine for autonomous driving, may be an on-board computing system or a mobile device such as an iPhone™ manufactured by Apple™, Inc or one manufactured by LG™, HTC™ and Samsung™, for example, or other device in communication with the vehicle or other machine and configured to send control commands thereto and to receive information on human interventions from the vehicle or other machine.

As shown, the mobile computer device 900 includes the following components in electronic communication via a bus 906, and to other devices or systems over network 920:
(a) a display 902;
(b) non-volatile (non-transitory) memory 904;
(c) random access memory (“RAM”) 908;
(d) N processing components 910;
(e) a transceiver component 912 that includes N transceivers; and
(f) user controls 914.

Although the components depicted in FIG. 9 represent physical components, FIG. 9 is not intended to be a hardware diagram. Thus, many of the components depicted in FIG. 9 may be realized by common constructs or distributed among additional physical components. Moreover, it is certainly contemplated that other existing and yet-to-be developed physical components and architectures may be utilized to implement the functional components described with reference to FIG. 9.

The display 902 generally operates to provide a presentation of content to a user, and may be realized by any of a variety of displays (e.g., CRT, LCD, HDMI, micro-projector and OLED displays).

In general, the non-volatile data storage 904 (also referred to as non-volatile memory) functions to store (e.g., persistently store) data and executable code. The system architecture may be implemented in memory 904, or by instructions stored in memory 904.

In some embodiments for example, the non-volatile memory 904 includes bootloader code, modem software, operating system code, file system code, and code to facilitate the implementation components, well known to those of ordinary skill in the art, which are not depicted nor described for simplicity.

In many implementations, the non-volatile memory 904 is realized by flash memory (e.g., NAND or ONENAND memory), but it is certainly contemplated that other memory types may be utilized as well. Although it may be possible to execute the code from the non-volatile memory 904, the executable code in the non-volatile memory 904 is typically loaded into RAM 908 and executed by one or more of the N processing components 910.

The N processing components 910 in connection with RAM 908 generally operate to execute the instructions stored in non-volatile memory 904. As one of ordinarily skill in the art will appreciate, the N processing components 910 may include a video processor, modem processor, DSP, graphics processing unit (GPU), and other processing components.

The transceiver component 912 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The system 900 of FIG. 9 may be connected to any appliance 418, such as one or more cameras mounted to the vehicle, a speedometer, a weather service for updating local context, or an external database from which context can be acquired.

It should be recognized that FIG. 9 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 904. Non-transitory computer-readable medium 904 includes both computer storage medium and communication medium including any medium that facilitates transfer of a computer program from one place to another. A storage medium may be any available medium that can be accessed by a computer.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A system for determining a predicted trajectory of a moving object, comprising:
memory; and
at least one processor in communication with the memory, wherein the memory stores machine-readable instructions for causing the at least one processor to:
receive historical trajectory data for the moving object and for one or more neighbouring objects;
pass the historical trajectory data to a recurrent neural network (RNN) encoder to generate dynamic features for the moving object and the one or more neighbouring objects;
construct a graph representing interactions between the moving object and the one or more neighbouring objects, wherein each node of the graph represents either the moving object or one of neighbouring objects, and comprises the respective dynamic features of moving object or said one of the neighbouring objects, and each edge represents an effect of the moving object on a neighbouring object or vice versa, or an effect of a neighbouring object on another neighbouring object;
pass the graph and the dynamic features to a graph neural network (GNN) encoder to generate a plurality of interaction features; and
pass the dynamic features and the interaction features to a RNN decoder to generate the predicted trajectory.

2. A system according to claim 1, wherein the graph is a directed graph.

3. A system according to claim 2, wherein the graph is a star-like graph.

4. A system according to claim 1, wherein the RNN encoder is a gated recurrent unit (GRU).

5. A system according to claim 4, wherein the GRU is a 1-layer GRU.

6. A system according to claim 1, wherein the RNN decoder is a LSTM.

7. A system according to claim 1, wherein the GNN comprises two graph attention network (GAT) layers.

8. A system according to claim 7, wherein the GAT layers utilise a three-head attention mechanism.

9. A system according to claim 1, wherein the moving object and/or the one or more neighbouring objects is or are a vehicle or vehicles.

10. A system for determining a plurality of predicted trajectories of a moving object, the method comprising:
memory; and
at least one processor in communication with the memory,
wherein the memory stores machine-readable instructions for causing the
at least one processor to:
obtain historical trajectory data for the moving object and for one or more neighbouring objects;
pass the historical trajectory data to an agent encoder to generate dynamic features for the moving object and the one or more neighbouring objects;
pass the historical trajectory data and candidate centre-lines (CCLs) of the moving object and the neighbouring objects to a CCL encoder to generate sequential features for the CCLs of the moving object and the neighbouring objects;
construct a graph representing interactions between the moving object and the one or more neighbouring objects, between the moving object and the moving object's candidate centre-lines, and between each neighbouring object and each neighbouring object's respective candidate centre-lines, wherein each node of the graph represents the moving object, or one of the moving object's candidate centre-lines, or one of the neighbouring objects, or one of each neighbouring object's respective candidate centre-lines,
wherein each node of the graph comprises the respective dynamic features of the moving object or the neighbouring objects, and comprises respective sequential features of the moving object's candidate centre-lines or each neighbouring objects' respective candidate centre-lines,
wherein each edge of the graph represents an effect of the moving object on a neighbouring object or vice versa, or an effect of the moving object and the moving object's candidate centre-lines or vice versa, or an effect of each neighbouring object and said each neighbouring object's respective candidate centre-lines or vice versa;
pass the graph, the dynamic features, and the sequential features to a plurality of graph neural network (GNN) encoders to generate a plurality of interaction features; and
pass the dynamic features, the interaction features, and the sequential features to a decoder to generate the predicted trajectories.

11. A method of determining a predicted trajectory of a moving object, the method comprising:
obtaining historical trajectory data for the moving object and for one or more neighbouring objects;
passing the historical trajectory data to a recurrent neural network (RNN) encoder to generate dynamic features for the moving object and the one or more neighbouring objects;
constructing a graph representing interactions between the moving object and the one or more neighbouring objects, wherein each node of the graph represents one of the moving object or one of neighbouring objects, and comprises the respective dynamic features of the moving object or the one or more neighbouring objects, and each edge represents an effect of the moving object on a neighbouring object or vice versa, or an effect of a neighbouring object on another neighbouring object;
passing the graph and the dynamic features to a graph neural network (GNN) encoder to generate a plurality of interaction features; and
passing the dynamic features and the interaction features to a RNN decoder to generate the predicted trajectory.

12. A method according to claim 11, wherein constructing a graph comprises constructing a directed graph.

13. A method according to claim 12, wherein constructing a directed graph comprises constructing a star-like graph.

14. A method according to claim 11, wherein passing the historical trajectory data to a RNN encoder comprises passing the historical trajectory data to a gated recurrent unit (GRU).

15. A method according to claim 11, wherein the RNN decoder is a LSTM.

16. A method according to claim 11, wherein the GNN comprises two graph attention network (GAT) layers.

17. A method according to claim 16, wherein the GAT layers utilise a three-head attention mechanism.

18. A method according to claim 11, wherein the moving object and/or the one or more neighbouring objects is or are a vehicle or vehicles.

19-20. (canceled)
